(19) United States
(12) Patent Application Publication
(10) Pub. No.: US 2006/0021049 A1
(43) Pub. Date: Jan. 26, 2006

(54) Techniques for identifying vulnerabilities in a network

(76) Inventor: Chad L. Cook, North Attleborough, MA (US)

Correspondence Address: FISH & RICHARDSON PC, P.O. BOX 1022, MINNEAPOLIS, MN, 55440-1022, US

(21) Appl. No.: 10/897,321

(22) Filed: Jul. 22, 2004

(51) Int. Cl. G06F 11/00

(52) U.S. Cl. 726/25

(57) ABSTRACT

The invention features a method and related computer program product and apparatus for assessing the security of a computer network.

### BACKGROUND

A security analysis for a computer network measures how easily the computer network and systems on the computer network can be compromised. A security analysis can assess the security of the networked system's physical configuration and environment, software, information handling processes, and user practices. A network administrator or user can make decisions related to process, software, or hardware configuration and implement changes based on the results of the security analysis.

### SUMMARY

In one aspect, the invention features a method that includes identifying vulnerabilities of a network based on a set of known vulnerabilities related to characteristics of the network. The method also includes simulating, based on the characteristics of the network and the identified vulnerabilities, at least one attack on a target in the network. The method also includes calculating at least one time value representative of an estimated time to compromise the target based on the simulated attack.

In another aspect, the invention features a computer program product tangibly embodied in an information carrier, for executing instructions on a processor. The computer program product is operable to cause a machine to identify vulnerabilities of a network based on a set of known vulnerabilities related to characteristics of the network. The computer program product also includes instructions to cause a machine to simulate, based on the characteristics of the network and the identified vulnerabilities, at least one attack on a target in the network. The computer program product also includes instructions to cause a machine to calculate at least one time value representative of an estimated time to compromise the target based on the simulated attack.

In another aspect, the invention features an apparatus configured to identify vulnerabilities of a network based on a set of known vulnerabilities related to characteristics of the network. The apparatus is also configured to simulate, based on the characteristics of the network and the identified vulnerabilities, at least one attack on a target in the network. The apparatus is also configured to calculate at least one time value representative of an estimated time to compromise the target based on the simulated attack.

### DESCRIPTION OF DRAWINGS

FIG. 1 is a block diagram of a network in communication with a computer running an analysis engine.

FIG. 2 is a block diagram of data flow in the security analysis system

FIG. 3 is a block diagram of a modeling engine and various inputs and outputs of the modeling engine.

FIG. 4 is a diagram that depicts security syndromes.

FIG. 5 is a flow chart of an authentication syndrome process.

FIG. 6 is a flow chart of an authorization syndrome process.

FIG. 7 is a flow chart of an accuracy syndrome process.

FIG. 8 is a flow chart of an availability syndrome process.

FIG. 9 is a flow chart of an audit syndrome process.

FIG. 10 is a flow chart of a security evaluation process.

FIG. 11 is a block diagram of inputs and outputs to and of attack trees and time to defeat algorithms.

FIG. 12 is a flow chart of a security analysis process.

FIG. 13 is a diagrammatical view of an attack tree.

FIG. 14 is a diagrammatical view of an exemplary attach tree for an accuracy syndrome.

FIG. 15 is a diagrammatical view of an exemplary attack tree for an authentication syndrome.

FIG. 16 is a flow chart of a technique to generate an attack tree.

FIG. 17 is a block diagram of an attribute.

FIG. 18 is a diagram that depicts time to defeat algorithm variables.

FIG. 19 is an example of a time to defeat algorithm.

FIGS. 20-26 are screenshots of outputs displaying results from the analysis system.

FIG. 27 is a block diagram of a metric pathway.

FIG. 28 is a flow chart of an iterative security determination process.

### DESCRIPTION

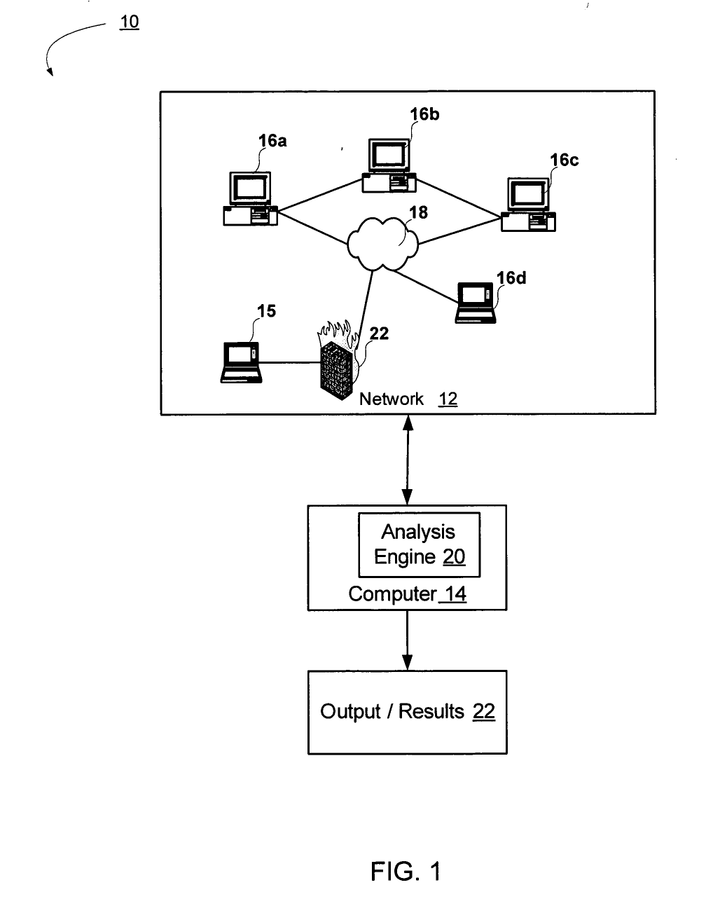

Referring to FIG. 1, a system 10 includes a network 12 in communication with a computer 14 that includes an analysis engine 20. The analysis engine 20 analyzes and evaluates security features of network 12. For example, the security of a network can be evaluated based on the ease of access to an object or target within the network by an entity. Analysis engine 20 receives input about the network topology and characteristics and generates a security indication or result 22. For example, network 12 includes multiple computers (e.g., 16a-14d) connected by a network or communication system 18. A firewall separates another computer 15 from computers 16a-16d in network 12. In order to produce an indication of the level of security of network 12, analysis engine 20 uses multiple techniques to measure the likelihood of the network being compromised.

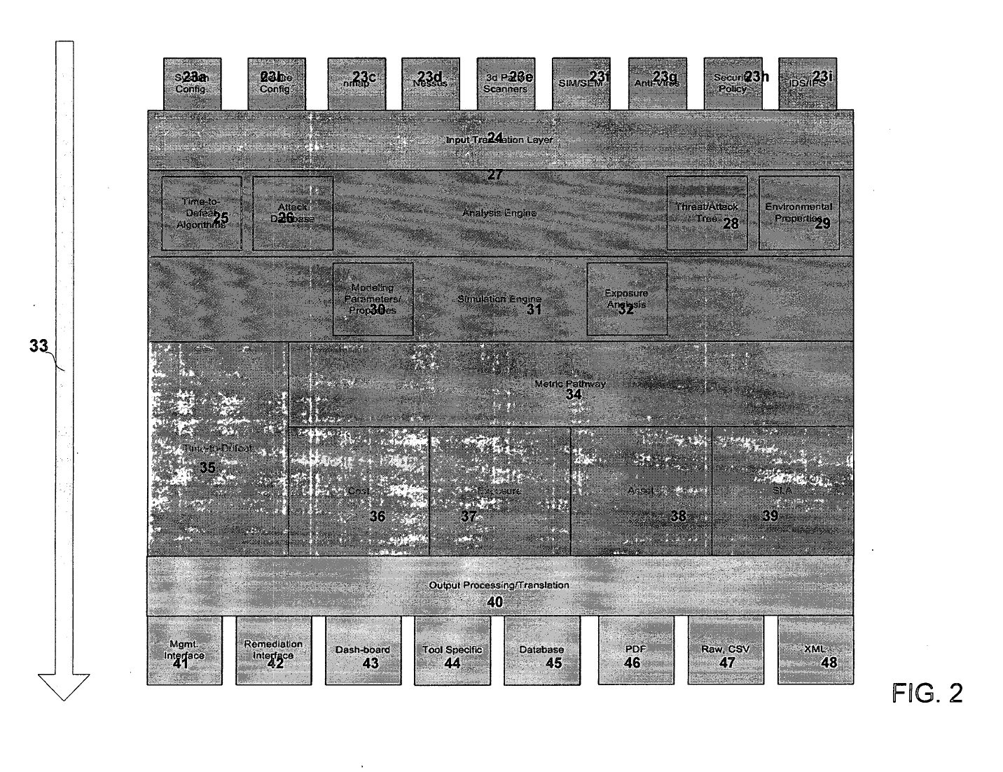

Referring to FIG. 2, an overview of data flow and interaction between components of the security analysis system is shown. The direction of data flow is indicated by arrow 33. Multiple inputs 23a-23i provide data to an input translation layer 24. The data represents a broad range of information related to the system including information related to the particular network being analyzed and information related to current security and attack definitions. Examples of data and tools providing data to the system include system configurations 23a, device configurations 23b, the open-source network scanner software package called “nmap” 23c, the open-source vulnerability analysis software package called “Nessus” 23d, commercial third party scanning tools to obtain network data 23e, a security information management system (SIM) device or a security event management system (SEM) device 23f, anti-virus programs 232g, security policy 23h, intrusion detection system (IDS), or intrusion prevention system (IPS) 23i. Other tools could of course be used.

The data from the sources 23 is input into the input translation layer 24 and the translation layer 24 translates the data into a common format for use by the analysis engine 27. For example, the input translation layer 24 takes output from disparate input data sources 23a-23i and generates a data set used for attack tree generation and time to defeat calculations (as described below). For example, the input translation layer 24 imports Extensible Markup Language (XML)-based analysis information and data from other tools and uses XML as the basis internal data representation.

As described above, the analysis engine 27 uses time to defeat (TTD) algorithms 25 and attack trees 28 to provide time to defeat (TTD) values that provide an indication of the level of security for the network analyzed. Security is characterized according to plural security characteristics. For instance, five security syndromes are used.

The TTD values are calculated based on the applicable forms of attack for a given environment. Those forms of attack are categorized to show the impact of such an attack on the network or computer environment. In the analysis engine 27, the attack trees are generated. The attack trees are based on, for example, network analysis and environmental analysis information used to build a directed graph (i.e. an attack tree) of applicable attacks and security relationships in a particular environment. The analysis engine 27 includes an attack database 26 of possible attacks and weaknesses and a set of environmental properties 29 that are used in the TTD algorithm generation.

For any network or computer system, there is a set of network services used by the network and/or computer system and for each of the services; there is a set of potential security weaknesses and attacks. The input from the network scanner 23c identifies which services are running and, therefore, are applicable for the given network or computer environment using the input translation layer 24. The vulnerability analysis 23 identifies applicable weaknesses in services used by the network. The environmental information 29 further indicates other forms of applicable weakness and the relationships between those systems and services. Based on this information, the simulation engine 31 correlates the information with a database of weaknesses and attacks 26 and generates an attack tree 28 that reflects that network or computer environment (e.g., represents the services that are present, which weaknesses are present and which forms of attack the network is susceptible to as nodes in the tree 28). The time to defeat algorithms 25 simulate the applicable forms of attack and TTD values are calculated using the TTD algorithms. The TTD results are compared/displayed to show the points of least resistance, based on their categorization into the aforementioned security syndromes.

The above example relates to an as-is-currently-present analysis of the environment. To do the modeling of what-if scenarios (changes to the environment), the parameters (variables) in the algorithms are exposed and modifiable so the user can generate virtual environments to see the affects on security.

The simulation engine 31 reconciles the network or computer environmental information with external inputs and algorithms to generate a time value associated with appropriate security relationships based on the attack trees and end-to-end TTD algorithms. The simulation engine 31 includes modeling parameters and properties 30 as well as exposure analysis programs 32. The simulation engine provides TTD results 35 or provides data to a metric pathway 34, which generates other metrics (e.g., cost 36, exposure 37, assets 38, and Service Level Agreement (SLA) data 39) using the provided data.

The TTD results 35 and other metrics 36, 37, 38, and 39 are displayed to a user via an output processing and translation layer 40. The output processing and translation layer 40 uses the results to produce an output desired by a user. The output may be tool or user specific. Examples of outputs include the use of PDF reports 46, raw data export 47, extensible markup language (XML) based export of data and appropriate schema 48, database schema 45, and ODBC export. Any suitable database products can be used. Examples include Oracle, DB2, and SQL. The results can also be exported and displayed on another interface such as a Dashboard output 43 or by remote printing.

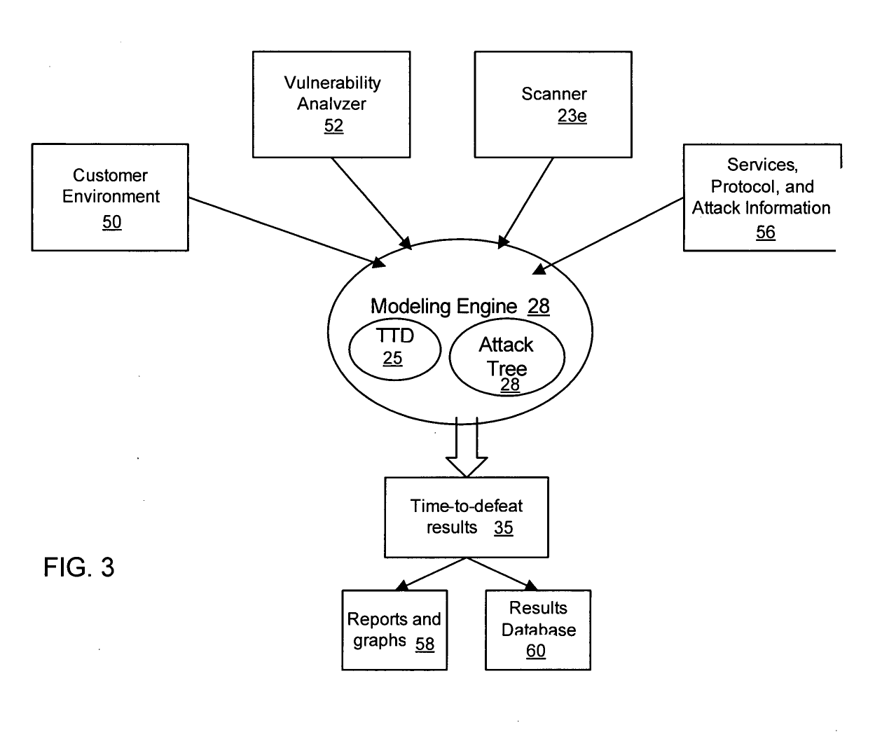

Referring to FIG. 3, one possible path for information flow through the components described in FIG. 1 is shown. The modeling and analysis engine 31 using the attack tree 28 and a time-to-defeat (TTD) algorithm 25 generates a security indication in the form of a time-to-defeat (TTD) value 35. The Time-to-defeat value is a probability based on a mathematical simulation of a successful execution of an attack. The time-to-defeat value is also related to the unique network or environment of the customer and is quantified as a length of time required to compromise or defeat a given security syndrome in a given service, host, or network. Security syndromes are categories of security that provide an overall assessment of the security of a particular service, host, or network, relative to the environment in which the service, host, or network exists. Examples of compromises include host and service compromises, as well as loss of service, network exposure, unauthorized access, or data theft compromises.

TTD values or results are determined from TTD algorithms 25 that estimate the time to compromise the target using potential attack scenarios as the attacks would occur if implemented on the environment analyzed. Therefore, TTD values 35 are specific to the environment analyzed and reflect the actual or current state of that environment.

The time-to-defeat results 35 are based on inputs from multiple sources. For example, inputs can include the customer environment 50, vulnerability analyzers 51, scanners 23e, and service, protocol and/or attack information 53. Using the input data, modeling and analysis engine 31 uses attack trees 28 and time-to-defeat techniques 25 to generate the time-to-defeat results or values 35. Processing of the time-to-defeat results generates reports and graphs to allow a user to access and analyze the time-to-defeat results 35. The results 35 may be stored in a database 60 for future reference and for historical tracking of the network security.

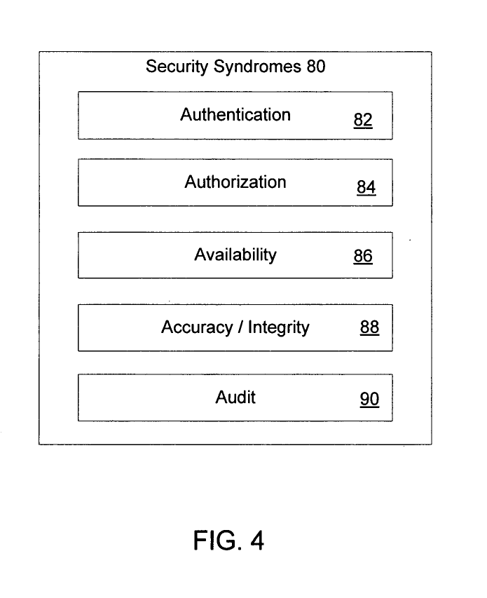

Referring to FIG. 4, a set of security syndromes 80 is used to categorize, measure, and quantify network security. In this example, the set of security syndromes 80 includes five syndromes. The analysis engine examines security in the network example according to these syndromes to categorize the overall and relative levels of security within the overall network or computer environment. The security syndromes included in this set 80 are authentication 82, authorization 84, availability 86, accuracy 88, and audit 90. While in combination the five security syndromes 80 provide a cross-section of the security for an environment, a subset of the five security syndromes 80 could be used to provide security information. Alternatively, additional syndromes could be analyzed in addition to the five syndromes shown in FIG. 3.

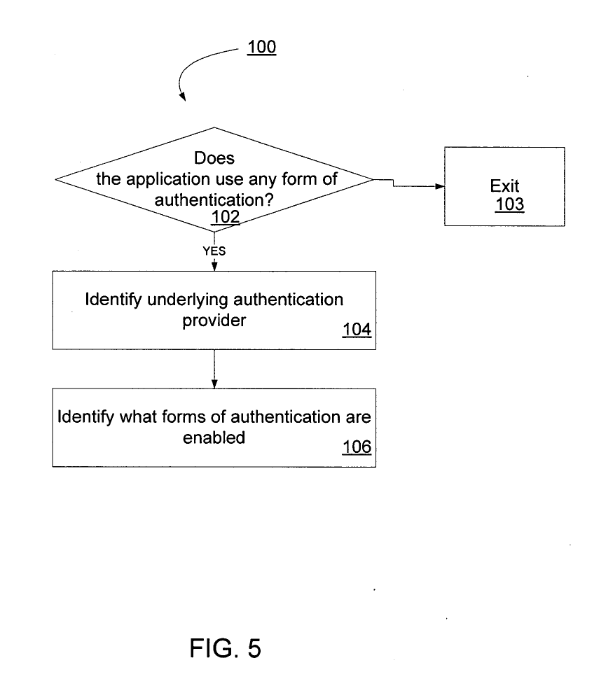

Evaluation of the five security syndromes 80 enables identification of weaknesses in security areas across differing levels of the network (e.g., services, hosts, networks, or groups of each). The results of the security analysis based on the security syndromes 80 provides a set of common data points spanning different characteristics and types of attacks that allow for statistical analysis. For each of the security syndromes, the system analyzes a different set of system or network characteristics, as shown in FIGS. 5-9.

Referring to FIG. 5, a process 100 for identifying network characteristics related to the authentication security syndrome 82 is shown. The authentication syndrome 82 analyzes the security of a target based on the identity of the target or based on a method of verifying the identity. When the system evaluates an authentication syndrome 82, the system determines 102 if the application uses any form of authentication. If no forms of authentication are used, the system exits 103 process 100. Forms of authentication can include, for example, user authentication and access control, network and host authentication and access control, distributed authentication and access control mechanisms, and intra-service authentication and access control. Identifying authentication security syndromes 82 can also include identifying 104 the underlying authentication provider (e.g., TCP Wrappers, IPTables, IPF filtering, UNIX password, strong authentication via cryptographic tokens or systems) and determining 106 what forms of authentication (if any) are enabled either manually or by default.

The information about forms of authentication can be received from the scanner or can be based on common or expected features of the service. Particular services have various forms of authentication these forms are authentication are identified and considered during the attack tree generation and TTD calculations.

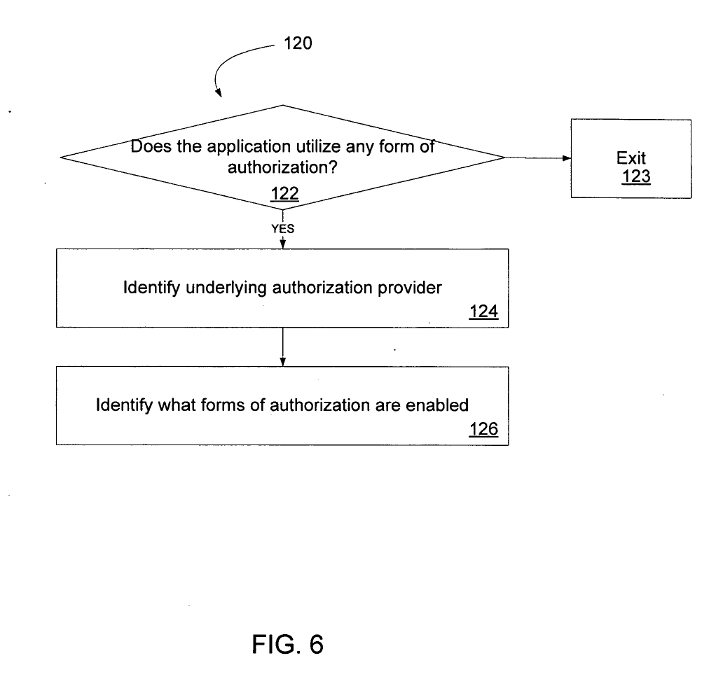

Referring to FIG. 6, a process 120 for identifying authorization security syndromes 84 is shown. The authorization syndrome 84 analyzes the security of a target or network based on the relationship between the identity of the attacker and type of attack and the data being accessed on the target. This process is similar to process 100 and includes determining 122 if the application uses any form of authorization. If no forms of authorization are used, the system exits 123 process 120. If the system used some form of authorization, process 120 identifies 124 the underlying authentication/authorization provider, and determining 126 forms of authorization enabled either manually or by default.

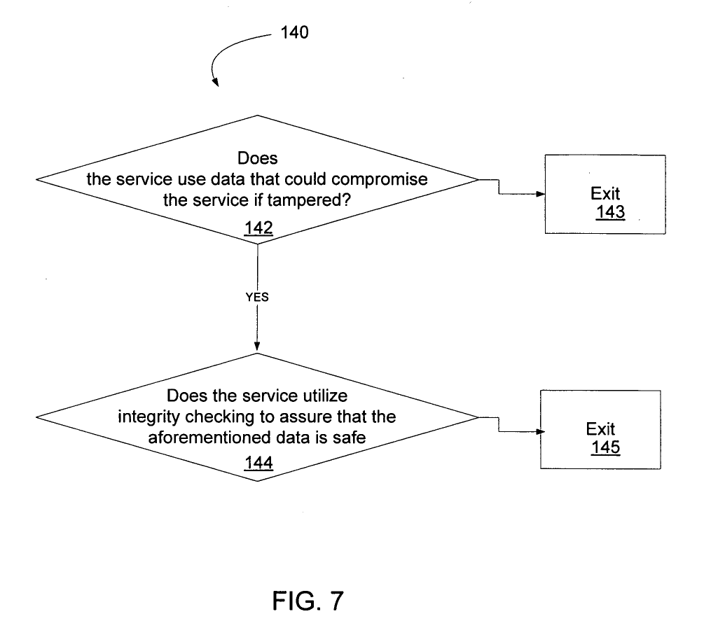

Referring to FIG. 7, a process 140 for determining network characteristics related to the accuracy/integrity security syndrome 88 is shown. The accuracy syndrome 88 analyzes the security of a target or network based on the integrity of data expressed, exposed, or used by an individual, a service, or a system. The process 140 includes determining 142 if the service includes data that, if tampered, could compromise the service and determining 144 if the service uses any form of integrity checking to assure that the aforementioned data is secure. If does not include such data or does not use integrity checking, process 140 exits 143 and 145.

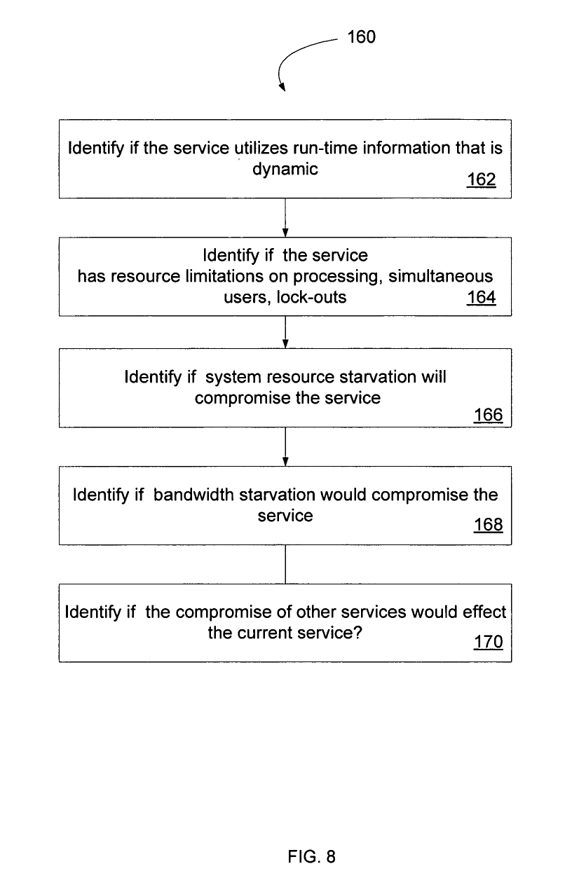

Referring to FIG. 8, a process 160 for identifying network security characteristics related to the availability security syndrome 86 is shown. The availability syndrome 86 analyzes the security of a target or network based on the ability to access or use a given service, host, network, or resource. Process 160 determines 162 if a service uses dynamic run-time information and identifies 164 if the service has resource limitations on processing, simultaneous users, or lock-outs. Process 160 identifies if system resource starvation 166 or bandwidth starvation 168 would compromise the service. For example, process 140 determines if starvation of a file system, memory and buffer space would compromise the service. If the service interacts with other services, process 160 determines additionally 170 if compromise of those services would effect the current service.

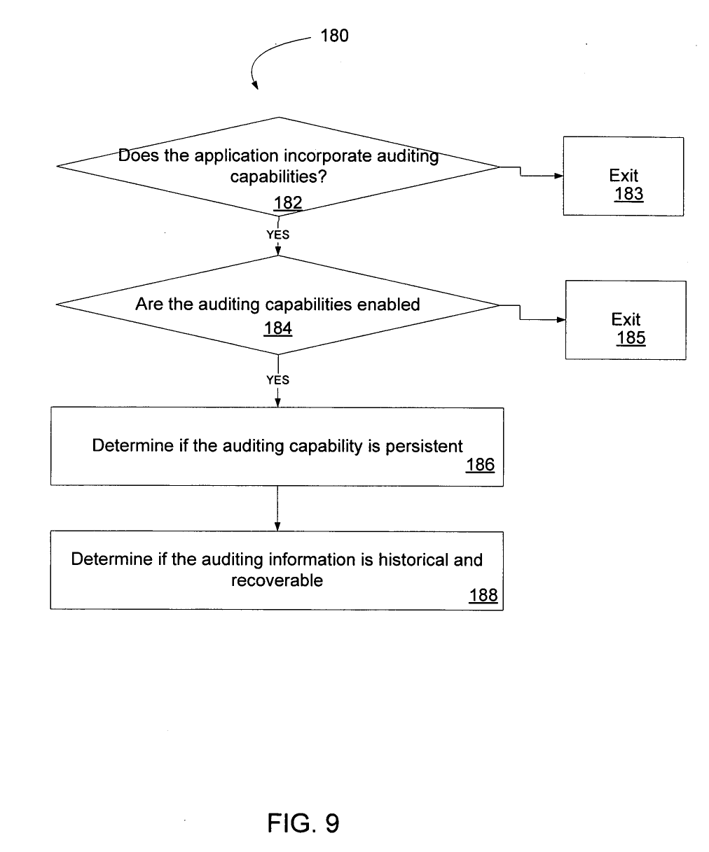

Referring to FIG. 9, a process 180 for identifying network security characteristics related to the audit security syndrome 90 is shown. The audit syndrome 90 analyzes the security of a target or network based on the maintenance, tracking, and communication of event information within the service, host, or network. Analysis of the audit syndrome includes determining 182 if the application incorporates auditing capabilities. If the system does not include auditing capabilities, process 180 exits 183. If the system does include auditing capabilities, process 180 determines 184 if the auditing capabilities are enabled either manually or by default. Process 180 includes determining 186 if a compromise of the audit capabilities would result in service compromise or if the service would continue to function in a degraded fashion. Process 180 also includes determining if the auditing capability is persistent and determining 188 if the audit information is historical and recoverable. If process 180 determines that the capabilities are not persistent, process 180 exits 185.

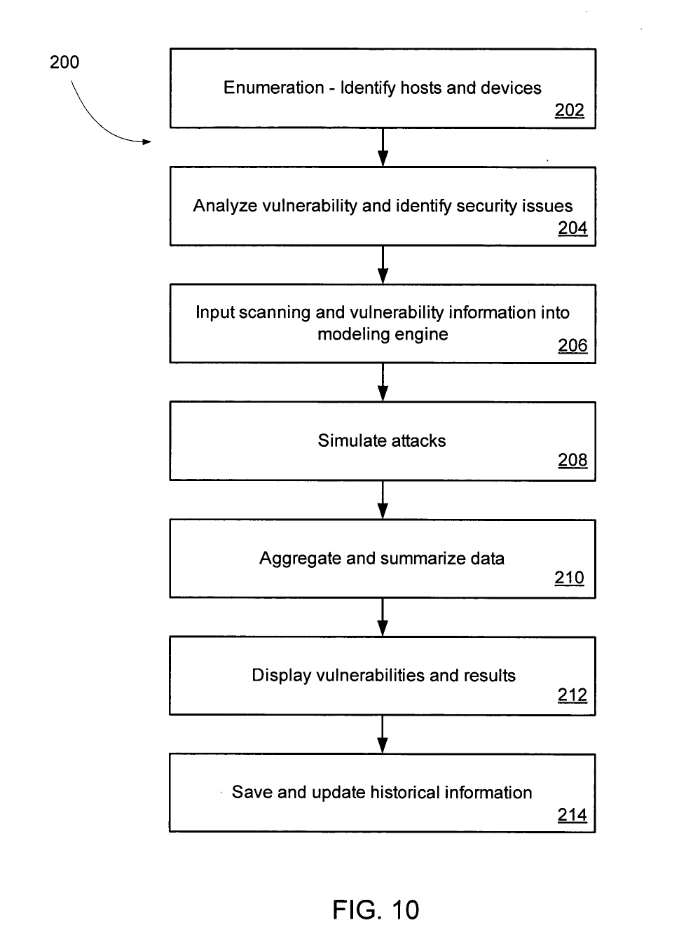

Referring to FIG. 10, a process 200 for analyzing the security of a network or target is shown. Process 200 analyzes the five security syndromes 80 (described above). Process 200 includes enumeration and identification 202 of the hosts and devices present in the network. Process 200 analyzes 204 the vulnerability and identifies security issues. Process 200 inputs 206 scanning and vulnerability information into the modeling engine. The modeling engine simulates 208 attacks on the target, aggregates, and summarizes 210 the data. The attacks are simulated by generating an attack tree that includes multiple ways or paths to compromise a target. Based on the paths that are generated, time-to-defeat algorithms can be used to model an estimated time to compromise the target based on the paths in the attack tree. Actual attacks are not implemented on the network during the simulation of an attack, instead the attack trees and TTD algorithms provide a way to estimate possible ways an attack would be carried out and the associated amount of time for each attack. Process 200 displays 212 the vulnerabilities and results of the simulated attacks as a time-to-defeat values. Process 200 optionally saves and updates 214 historical information based on the results.

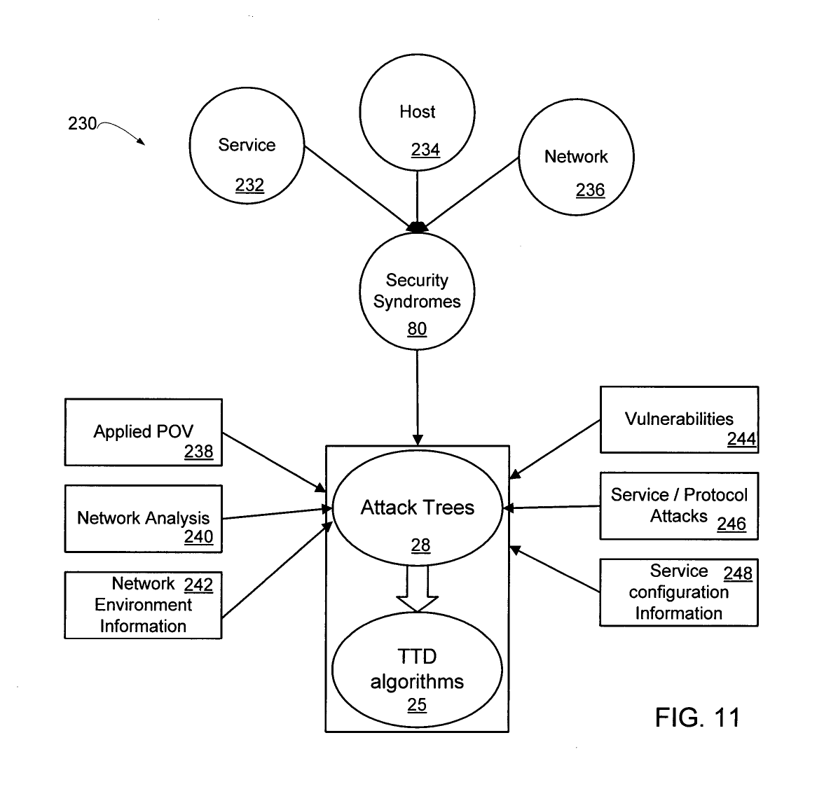

Referring to FIG. 11, information flow in the analysis engine 27 is shown. The analysis engine 27 uses attack trees and TTD techniques to generate time-to-defeat results based on information related to the network 14, possible attacks against the network, and the security syndromes 80. In order to evaluate the time-to-defeat for a target, information about a service 232, host 234, and the network 14 are used to generate and/or populate attack trees 28. The attack trees 28 are used to generate TTD algorithms 25. The network characteristics are analyzed and grouped according to the security syndromes 80.

Certain attacks may affect multiple syndromes. For example, a buffer overflow vulnerability may compromise authorization by allowing an unauthorized attacker to execute arbitrary programs on the system. In addition, while compromising the authorization, the original service may also be disabled, thereby affecting availability in addition to the authentication. However, if another form of attack on the availability syndrome, results in a smaller calculated amount of time to defeat the availability syndrome, the buffer overflow will not affect the time-to-defeat result because the shortest TTD is reported.

There can also be a relationship between attacks. For example, an attack on an information disclosure weakness could result in the compromise of a list of username and password hashes, thus, affecting the authorization syndrome (e.g., attacker would not normally have authorization to access said information). The username and password information can then be used to attack authentication.

The network characteristics that affect a particular syndrome are grouped and used in the evaluation of the TTD for that particular syndrome. The network security is evaluated independently for each of the security syndromes 80. The different evaluations can include different types of attacks as well as different related security characteristics of the network.

Information about possible attack methods and weaknesses are also input and used by the analysis engine 27. For example, applied point of view (POV) 238 can affect possible attack methods. For example, several points of view can be used and because security is context-sensitive and relative (from attacker to target), the levels of security and the requirements for security can vary depending on the point of view. Point of view is primarily determined by looking at a certain altitude (vertically) or longitude (horizontal). For example, the perspective can start at the enterprise level, which includes all of the networks, hosts and services being analyzed. A lower, more granular level shows the individual networks that have hosts. The individual hosts include services.

The point of view also allows the user to set attacker points or nodes (‘A’) and target points or nodes (‘T’) to see the levels of security from point or node ‘A’ to point or node ‘T.’ For example, the security looking from outside of a firewall towards an internal corporate network may be different from the security looking between two internal networks. In some examples, one would expect higher security at a point where hosts are directly accessible from the Internet, or between two internal networks such as the finance servers and the general employee systems.

Information about possible attack methods and weaknesses can also include network analysis 240, network environment information 242, vulnerabilities 244, service and protocol attacks 246, and service configuration information 248. The analysis engine 27 to generate attack trees 28 and TTD algorithms 25 uses such information. For example, the relationship between the attacker and the target can influence the attack trees 28 and the TTD algorithms. This includes looking from a specific host or network to another specific host or network. This is done via user-defined “merged” hosts, for example, systems that are multi-homed (e.g., on multiple networks). During the analysis, the system uses sets of targets as identified by IP addresses. On different networks, two or more of these IP addresses may in fact be the same machine (a multi-homed system). In the product, the user can “merge” those addresses indicating to the analysis/modeling engine that the two IP addresses are one system. This allows the analysis of the security that exists between those networks using the merged host as a bridge, router, or firewall.

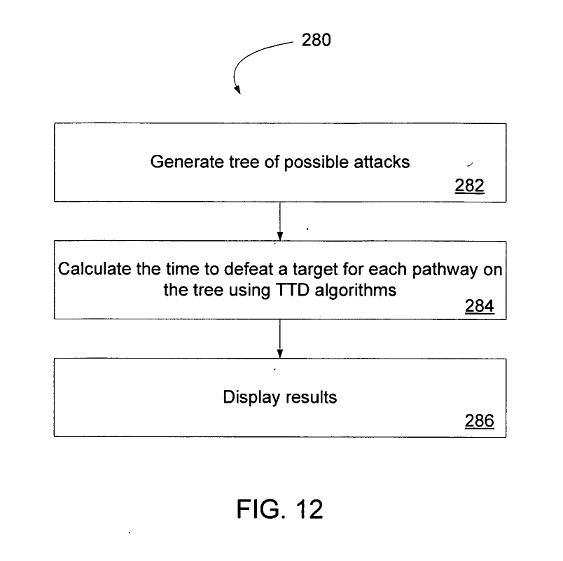

Referring to FIG. 12, a process 280 included in and executed by the analysis engine 27 for generating TTD results using TTD algorithms 25 and attack trees 28 is shown. An attack tree is a structured representation of applicable methods of attack for a particular service (e.g., a service on a host, which is on a network) at a granular level. The attack trees are generated 282 and evaluated to calculate 284 a time to defeat for a particular target. Multiple paths in the attack tree are analyzed to determine the path requiring the least time to compromise the target. These results are subsequently displayed 286. The attack tree structurally represents the vulnerabilities of a network, system and service such that the TTD algorithms can be used to calculate a time to defeat for a particular target.

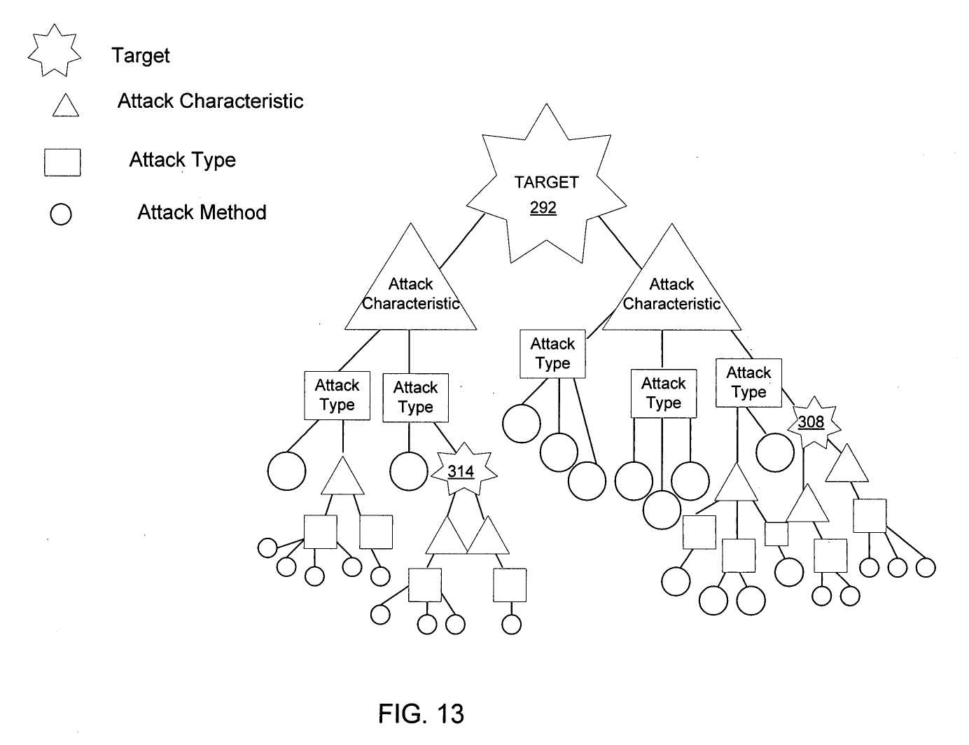

Referring to FIG. 13, an example of an attack tree 290 is shown. There may be multiple targets (e.g., targets 292, 314, and 308) in a single attack tree. The attack tree 290 includes targets (represented by stars and which can correspond to devices 14a-14c in FIG. 1), attack characteristics (represented by triangles), attack types (represented by rectangles), and attack methods (represented by circles). By determining methods of attack using these components, pathways for potential attacks can be generated. Each pathway represents a possible method of attack including the type of attack and the involved systems (i.e., targets) in the network.

Attack characteristics include general system characteristics that provide vulnerabilities, which can be exploited by different types of attacks. For example, the operating system may provide particular vulnerabilities. Each operating system provides a network stack that allows for IP connectivity and, consequently, has a related set of potential vulnerabilities in an IP protocol stack that may be exploited. There are also aspects of a given protocol, regardless of specific implementation that allow for attack. TCP/IP, for example, may have known vulnerabilities in the implementation of that stack (on Windows, Linux, BSD, etc), which are identified as a vulnerability using scanners or other tools. Other weaknesses in attacking the protocol may include the use of a Denial of Service type attack that the TCP/IP-based service is susceptible to. Exploitation of denial of service may exploit a weakness in the OS kernel or in the handling of connections in the application itself.

For another example, there are also the relationships between vulnerabilities. If there is a weakness that allows viewing of critical data, but requires someone to gain access to the system first, compromise of a user account would be one weakness to be exploited prior to exploitation of the specific vulnerability that allows data access. Attack types are general types of attacks related to a particular characteristic. Attack methods are the specific methods used to form an attack on the target 292 based on a particular characteristic and attack type. For example, in order to compromise a specific target (e.g., target 292) an attack may first compromise another target, e.g., target 308.

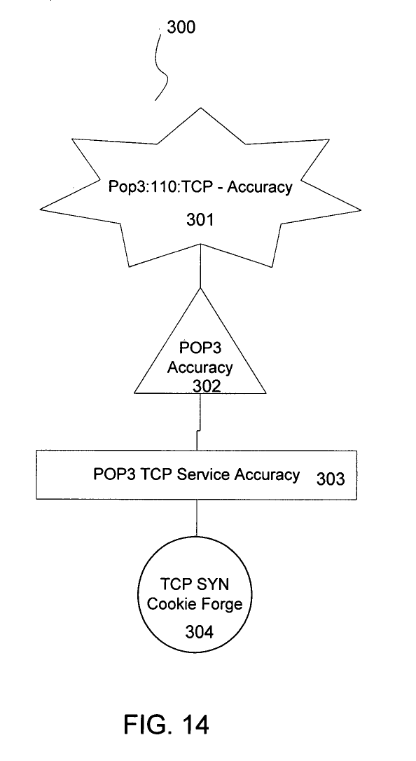

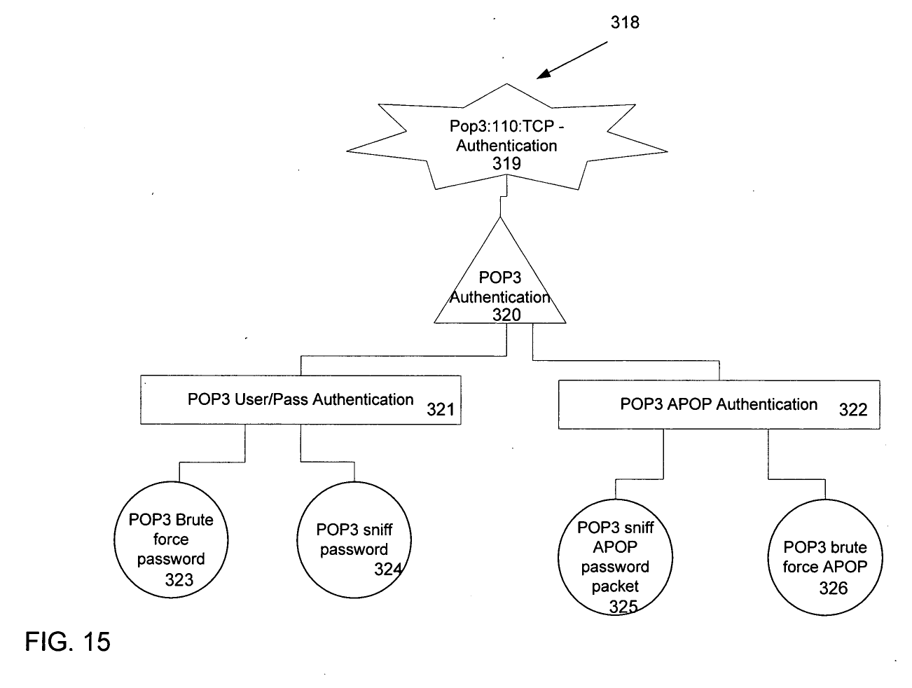

Referring to FIGS. 14-15, examples of attack trees based on the Post Office Protocol version 3 (POP3) protocol are shown. POP3 is an application layer protocol that operates over TCP port 110. POP3 is de-fined in RFC 1939 and is a protocol that allows workstations to access a mail drop dynamically on a server host. The typical use of POP3 is e-mail.

Referring to FIG. 14, an attack tree 300 for the accuracy syndrome based on the POP3 protocol is shown. A potential attack on an environment using the POP3 protocol related to the accuracy syndrome is a ‘TCP Syn Cookie Forge’ attack. The target 301 of the attack is the accuracy of a particular system. The characteristic 302 displayed in this attack tree is the POP3 Accuracy and the type of attack 303 is a POP3 TCP Service Accuracy attack. A TCP Syn Cookie Forge attack is related to the time it would take an attacker to successfully guess the sequence number of a packet in order to produce a forged Syn Cookie. A number of factors are included in a TTD calculation based on such an attack tree include bandwidth available to attacker and number of attacker computers.

Referring to FIG. 15, an attack tree 318 for the Authentication syndrome based on the POP3 protocol is shown. Multiple potential attacks on an environment using the POP3 protocol related to the Authentication syndrome are shown as different branches of the attack tree. The target 319 of each of the attacks is the accuracy of a particular system. The characteristic 320 displayed in this attack tree is the POP3 Authentication. Two types of attack for the POP3 authentication include user/pass authentication attacks 321 and POP3 APOP Authentication attacks 322. For each of the types of attacks multiple methods for implementing such an attack can exist. For example, methods of attacking the POP3 User/pass Authentication type 321 include POP3 Brute Force password methods 323 and POP3 Sniff password methods 324.

The POP3 Brute Force Password method 323 is related to the time it would take an attacker to log in by repeated guessing of passwords or other secrets across a user base. Limiting factors that can be used in a TTD algorithm related to this method of attack include User database size, Lockout delay between connections, Number of attempts per connection, dictionary attack size, total-password combinations, exhaustive search password length, number of attacker computers, bandwidth available to attacker, and number of hops between the attacker and the target. The POP3 Sniff Password method 324 is related to the time it would take an attacker to sniff a clear text packet including login data on a network. Limiting factors that can be used in a TTD algorithm related to this method of attack include SSL Encryption on or off and Number of successful authentication Connections per day. Similarly, additional methods 325 and 326 are included for the attack type 322.

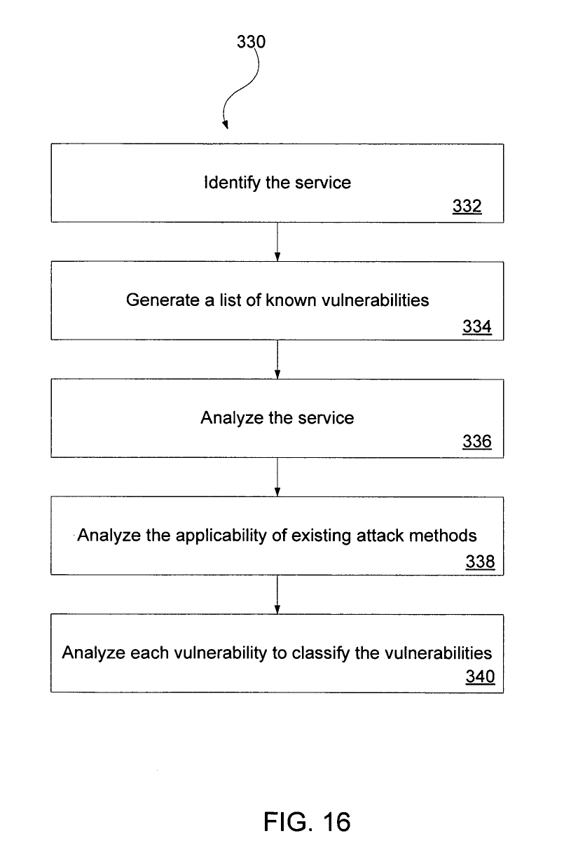

Referring to FIG. 16, a process 330 for generating an attack tree is shown. The network scanner 23c enumerates the targets that are on the network, via IP address, identifies the services running on each of those systems, returning the port number and name of the service. This information is received 332 by the vulnerability analyzer, which interacts with each of those systems and services. A list of vulnerabilities is generated 334 for the service. For example, the vulnerability analyzer identifies the OS running on the system, any vulnerabilities present for that OS and vulnerabilities for the services identified to be running on that system. Based on the vulnerabilities the system analyzes 336 how the service works. For example, modular decomposition can be employed to understand what components are included in the service. The external interfaces are examined so that any interaction or dependency that the service has with external libraries and applications is considered when generating the attack tree. This information is received by the analysis engine, which generates an attack tree for each service based on the vulnerabilities identified by the vulnerability analyzer and of the other weaknesses that the service is susceptible to as included in a database. Subsequent to analyzing 336 the services, process 330 analyzes 338 the applicability of existing attack methods based on a library of attack methods. The database includes known weaknesses/vulnerabilities including those reported by the vulnerability Analyzer and those that the tools do not readily identify. For example, tools may not identify some items that are not implementation flaws but are weaknesses by design. The relationship between the service and the underlying OS can also correlate to other forms of weakness and attack including dictionary attacks of credentials, denial of service and the relationships between various vulnerabilities and exploitation of the system. Once applicable methods of attack are gathered, they are analyzed 340 and categorized into the five characteristics or syndromes (as described in FIG. 3), resulting in up to five attack trees for each service. Each method of attack in the tree corresponds to an algorithm that is calculated and comparisons are made in order to show the result that is the shortest time to defeat.

The generation of an attack tree takes into consideration several factors including assumptions, constraints, algorithm definition, and method code. The assumption component outlines assumptions about the service including default configurations or special configurations that are needed or assumed to be present for the attack to be successful. The “modeling” capability can provide various advantages such as allowing a user to set various properties to more accurately reflect the network or environment, the profile of the attacker, including their system resources and network environment, and/or allowing a user to model “what-if” scenarios. Assumptions can also include the existence of a particular environment required for the attack including services, libraries, and versions. Other information that is not deducible from a determination of the layout and service for the network but necessary for the attack to succeed can be included in the assumptions.

The constraints component provides environmental information and other information that contributes to the numerical values and assumptions. Constraints can include processing resources of the target system and attacking system (e.g., CPU, memory, storage, network interfaces) and network bandwidth and environment (e.g., configuration/topology) used to establish the numerical values, and complexity and feasibility is also considered, such as the numerical value indicating the ease or ability to successfully exploit a vulnerability based on its dependencies and the environment in which it would occur. Assumptions and constraints are also listed for what is not expected to be present, configured, or available if the presence of such an object would affect the probability or implementation of an attack.

The algorithm definition component outlines the definition of the TTD algorithm used to calculate the TTD value for the given service. For example, the algorithm can be a concise, mathematical definition demonstrating the variables and methods used to arrive at the time to defeat value(s). The analysis engine generates TTD algorithms using algorithmic components in multiple algorithms in order to maintain consistency across TTDS.

For example, if multiple services include a similar password protection schema and the attacks on the password protection schema on the differing services can be implemented in similar ways, a standard representation or modeling of attacks to compromise the password protection is used. Thus, although the overall TTD algorithm may differ for different services, the time representation of the common component (and, thus, the calculated TTD time) will be consistent.

The method code component criteria are represented to the analysis engine via objects (e.g., C++ objects) and method code. The method code performs the actual calculation based on constant values, variable attributes, and calculated time values. While each method will have different attribute variables, the implementations can nevertheless have a similar format.

The methods that compute TTD values use an object implementation based on a service class, criteria class, and attribute class. The service class reflects the attack tree defined for that service, using criteria objects to represent the nodes in that attack tree. Service objects also have attributes that are used to determine the attack tree and criteria that are employed for the given service.

Criteria classes have methods that correspond to the methods of attack for the respective criteria. The criteria object also includes attributes that affect the calculations. In general, the attribute class includes variables that influence the attack and the TTD calculation. The attribute class performs modifications to the value passed to the class and has an effect on the TTD. For example, attributes can add, subtract, or otherwise modify the calculated time at various levels (service, criteria and methods). Attributes can also be used to enable or disable a given criteria or a given method within a criteria. This level of multi-modal attribute allows for the expansion of the TTD calculations provide scalable correlation metrics as new data points are considered.

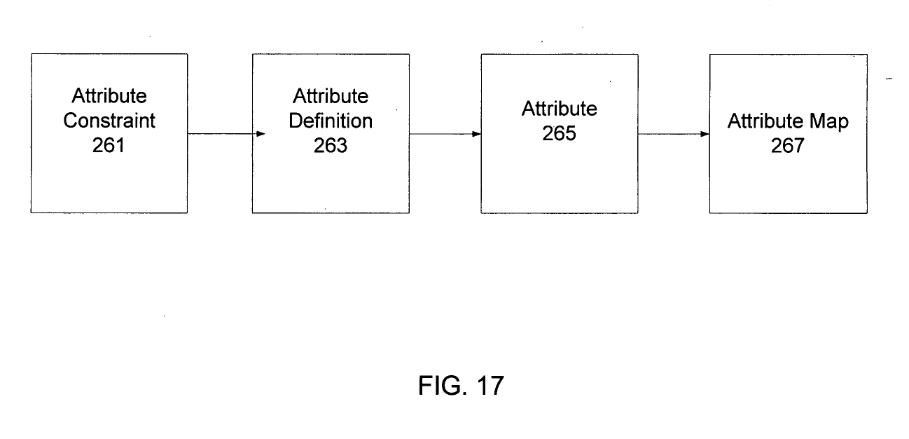

Referring to FIG. 17, the relationship between attribute constraints 261, attribute definitions 263, an attribute 265, and an attribute map 267 is shown. In general, an attribute map 267 is a set of attributes used to generate TTD algorithms and attack trees. The attribute map 267 includes a set of attributes 265 for a particular type of attack or for a particular set of vulnerabilities.

Each attribute 265 included in the attribute map 267 is an instantiation of an attribute for a particular instance of a vulnerability or characteristic of a network or system. Particular values or constraints can be set for an attribute 265. The values set for a particular attribute 265 may be network or system dependent or may be set based on a minimum level of security.

Attributes 265 are specific instantiations of general attribute definitions 263. An attribute definition is used to define a particular type or class of attributes 265 with common elements. For example, an attribute definition 263 can include default values for an attribute, the type of data the attribute will return, and the type of the data. Multiple attributes may be generated from one attribute definition 263.

The attribute definition 263 can be populated in part by data included in an attribute constraint 261. The attribute constraints 261 provide limitations for values in a particular attribute definition 263. For example, the attribute constraint 261 can be used to set a range of allowed values for a particular component of the attribute definition 263.

In general, the nested structure of the attribute constraints 261, attribute definitions 263, attributes 265, and attribute map 267 provides flexibility in the simulation system. For example, multiple attributes may have a field based on the network bandwidth. Since the attribute is populated in part based on the information included in the attribute definition 263 and the attribute definition 263 is populated in part based on the information included in the attribute constraint 261, if the network bandwidth changes only the attribute constraint is changed in the system in order to change the network bandwidth for each attribute including the network bandwidth as a field.

The time-to-defeat (TTD) value is based on a probabilistic or algorithmic representation to compute the time necessary to compromise a given syndrome of a given service. Generally, TTD values are relative values that are applied locally and may or may not have application on a global basis, due to the many variable factors that influence the time to defeat algorithm. For example, a time to defeat value is calculated based on particular characteristics of a network. Therefore, the same type of attack may result in a different TTD for the two networks due to differing network characteristics. Alternately, a network with a similar structure and security measures may be susceptible to different types of attacks and thus, result in different TTD values for the networks. Time to defeat values for vulnerabilities and attacks (criteria and methods) are calculations that consider the networks attributes and variables and any applicable constants.

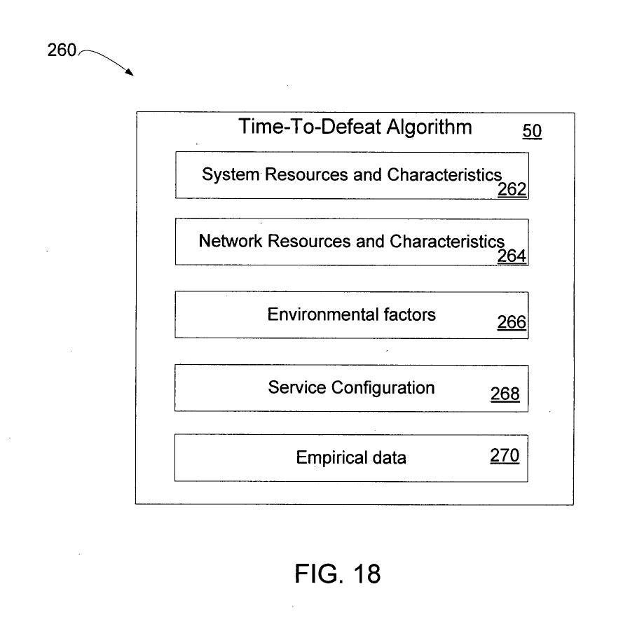

Referring to FIG. 18, factors used in time to defeat algorithms are shown. The TTD algorithms are dynamic and based on a number of factors applicable to a given service. Factors include, for example, system resources 262 such as attacker and target CPU, memory, and network interface speed, network resources 264 such as the distance from attacker to target, speed of the networks, and the available bandwidth. Environmental factors 266 such as network and system topology, existing security measures or conditions that influence potential or probable attack methods can also be included in the TTD algorithms. Service configurations 268 such as configuration options that present or prevent avenues of attack can also be included as a variable in a TTD algorithm. Empirical data 270 (e.g., constant values derived from multiple trials following the same attack process) can be used to gather objective time information such as time to download an attack from the Internet. While a number of factors have been described, other factors may also be used based on the analysis.

For a given service, TTD values (e.g., a calculated result of a TTD algorithm) are provided for each of the five security syndromes 80. The results of the analysis provide a range of TTD values including a maximum and a minimum TTD value for a given security syndrome. This data can be interpreted in a variety of ways. For example, a wide range in the TTD value can demonstrate inconsistencies in policy and/or a failure or lack of security in that respective security syndrome. A narrow range of high TTD values indicates a high or adequate level of security while a narrow range of low TTD values indicates a low level of security. In addition, no information for a particular security syndrome indicates that the given security syndrome 80 is not applicable to the analyzed network or service. Combined with environmental knowledge of critical assets, resources and data, the TTD analysis results can help to prioritize and mitigate risks.

Such information can be reflected in the reporting functionality. For example, during configuration the user can label the various components (e.g., networks and/or systems), with labels that are related to the functions performed by the components. These components could be labels such as “finance network,” “HR system,” etc. The reporting shows the labels and the user can use the information present to prioritize which networks, systems, etc. should be investigated first, based on the prioritization of that organization. In addition, a component can be assigned a weighted prioritization scheme. For example, the user can define particular assets and priorities on those assets (e.g., a numeric priority applied by the user), and the resulting report can show those prioritized assets and the risks that are associated with them.

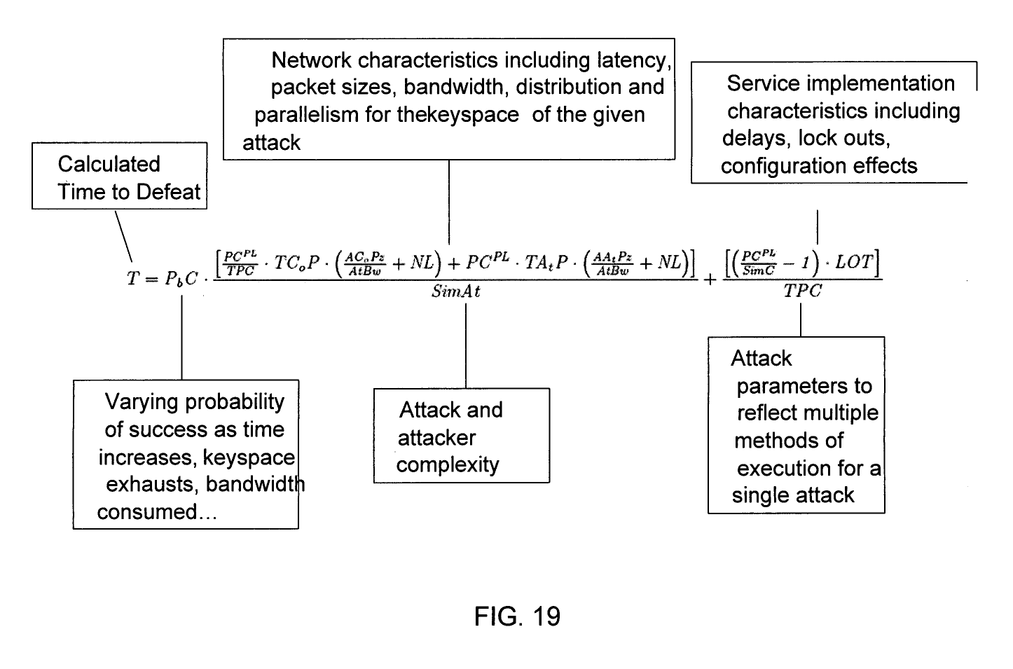

FIG. 19 shows an exemplary TTD algorithm. Based on the attack trees and TTD algorithms, a time value representing the time to compromise a target can be generated. Since multiple ways to attack a single target can exist, multiple time values can be calculated (e.g., one per attack pathway). A separate TTD algorithm is generated for each method of attack (e.g., for each pathway). The algorithms may include similar components as discussed above, but each algorithm is specific to the method of attack and the network. In order to present the information to a user, the time to defeat results are rendered in a variety of ways, e.g., via printer or display.

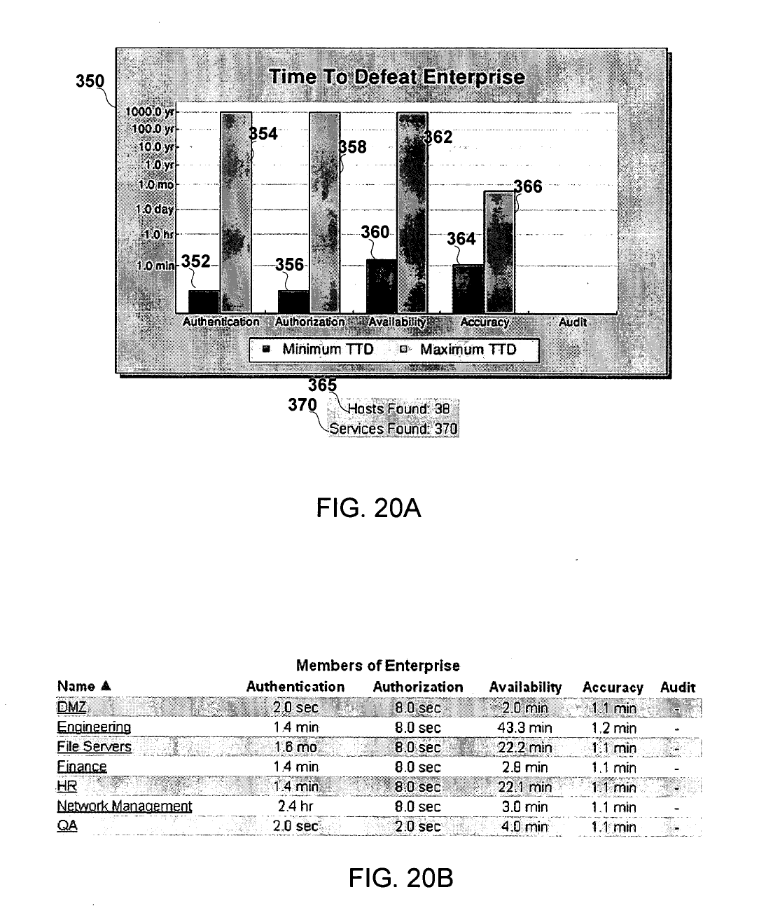

Referring to FIG. 20A, an enterprise-wide graph that depicts aggregate high and low time to defeat values for each of the security syndromes 80 is shown. The enterprise time-to-defeat graph aggregates and summarizes the data from, e.g., multiple analyzed networks, to provide an overall indication of security within the analyzed environment (comprising the multiple networks). Similar graphs and information can be depicted on a network, host, or service level basis.

In this example, the overall level of security is relatively low, as indicated by the minimum time-to-defeat values (354, 358, 362, 364), which are approximately one minute or less. The displayed minimum time-to-defeat values for each of the security syndromes correspond to the time to defeat the pathway in the syndrome's attack tree that has the lowest calculated time value (e.g., path with least resistance to attack). The maximum time-to-defeat values (354, 358, 362, 364) calculated for this environment vary depending on the security syndrome. The displayed maximum time-to-defeat values for each of the security syndromes correspond to the time to defeat the pathway in the syndrome's attack tree that has the highest calculated time value (e.g., path with greatest resistance to attack). By setting thresholds, an organization determines if the minimum and maximum time-to-defeat values are acceptable.

For a highly secured and managed environment, both the maximum and minimum Time-to-Defeat values should be consistently high across the five security syndromes 80, indicative of consistency, effective security policy, deployment and management of the systems and services in that enterprise environment.

Low authentication TTD values often result in unauthorized system access and stolen identities and credentials. The ramifications of low authentication TTD can be significant; if the system includes important assets and/or information, or if it exposes such a system, the effects of compromise can be significant. Low authorization TTD values indicate security problems that allow access to information and data to an entity that should not be granted access. For example, an unauthorized entity may gain access to files, personal information, session information, or information that can be used to launch other attacks, such as system reconnaissance for vulnerability exposure.

In addition to the TTD values, graph 350 includes an indication of the number of hosts 368 and services 370 found in the analyzed enterprise.

Referring to FIG. 20B, a listing of the Enterprise networks and the network's minimum time to defeat value for each security syndrome is shown. The detailed listing of the enterprise time-to-defeat information identifies the networks that have the lowest levels of security in the environment. In this example, seven networks have been configured for analysis and the display shows the lowest time to defeat values for the given networks. By analyzing the time-to-defeat values of the hosts and services on each of the networks, an organization or user makes decisions about which of the identified risks presents the largest threat to the overall environment. Based on the organization's business needs, the organization can prioritize security concerns and apply solutions to mitigate the identified risks.

In a typical environment, multiple distinct networks are analyzed. The calculated TTD results can be summarized to allow for a broader understanding of the areas of weakness that span the organization. The identified areas can be treated with security process, policy, or technology changes. The weakest networks (within the enterprise e.g., networks with the lowest TTD values) are also identified and can be treated when correlated with important company assets. Such a correlation helps provide an understanding of the security risks that are present. Viewing the analysis at the enterprise level, with network summaries, also provides an overview of the security as it crosses networks, departments, and organizations.

In addition, similar graphs including the maximum and minimum time to defeat values for each of the security syndromes can be generated at the host, network, or service level.

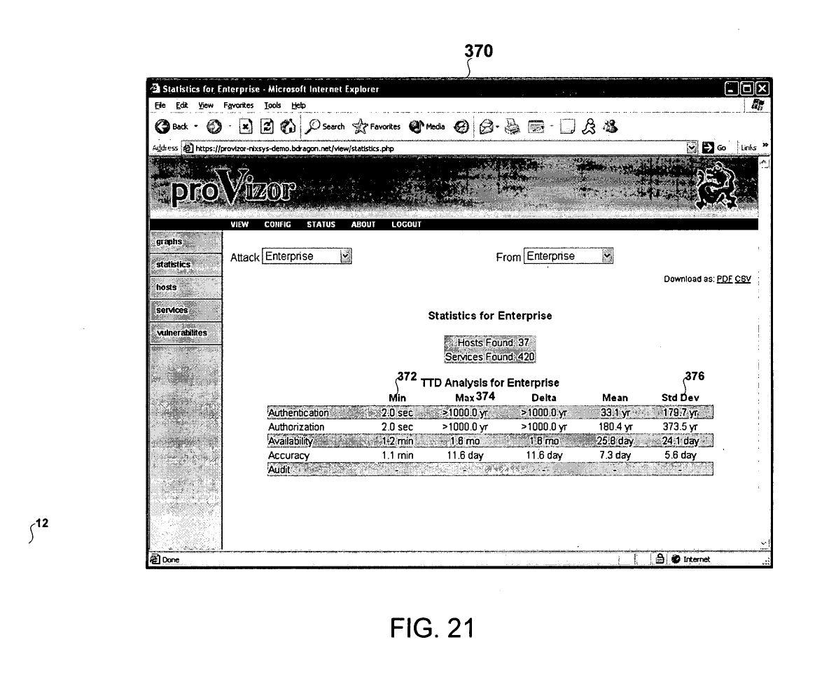

Referring to FIG. 21, an enterprise level statistics screenshot 370 for the five security syndromes aggregated across the analyzed services is shown. The statistics summary for the enterprise provides an overall indication of the security of the services found within that enterprise. This view identifies shortcomings in different security areas, and demonstrates the consistency of security within the entire environment. A large disparity between the minimum TTD 372 and the maximum TTD 374 time can indicate the presence of vulnerabilities, mis-configurations, failure in policy compliance, or ineffective security policy. A large standard deviation 376 summarizes the inconsistencies that merit investigation. Identifying the areas of security that are weakest allows organizations to prioritize and determine solutions to investigate and deploy for the environment.

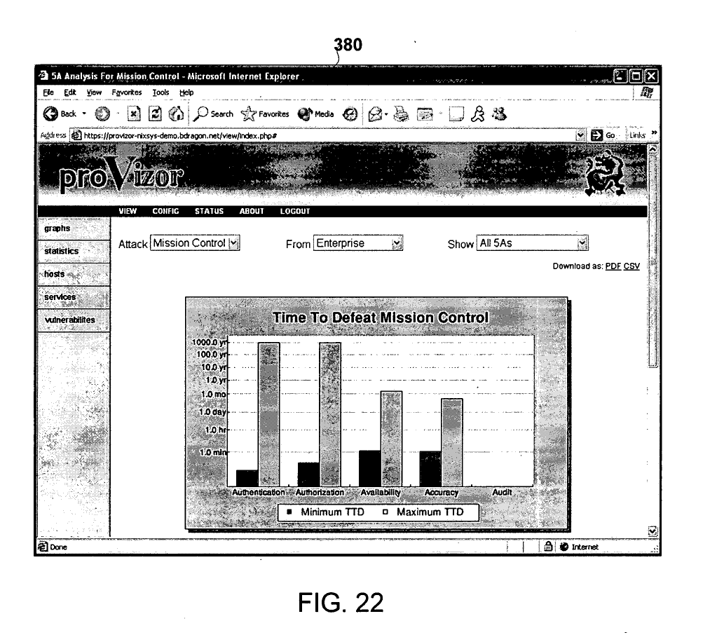

Referring to FIG. 22, a graph 390 of the hosts on a network and respective minimum time to defeat values for each of the security syndromes 80 is shown. At the host level, the time values are the shortest times across the services discovered on that host, which are therefore the weakest areas for that host. The lower time values indicate a level of insecurity due to the presence of specific vulnerabilities or inherent weaknesses in the service and/or protocol, or in the services implementation in the environment. Security syndromes that do not have a time value (represented by a dash) are not applicable for the services discovered and analyzed in that environment.

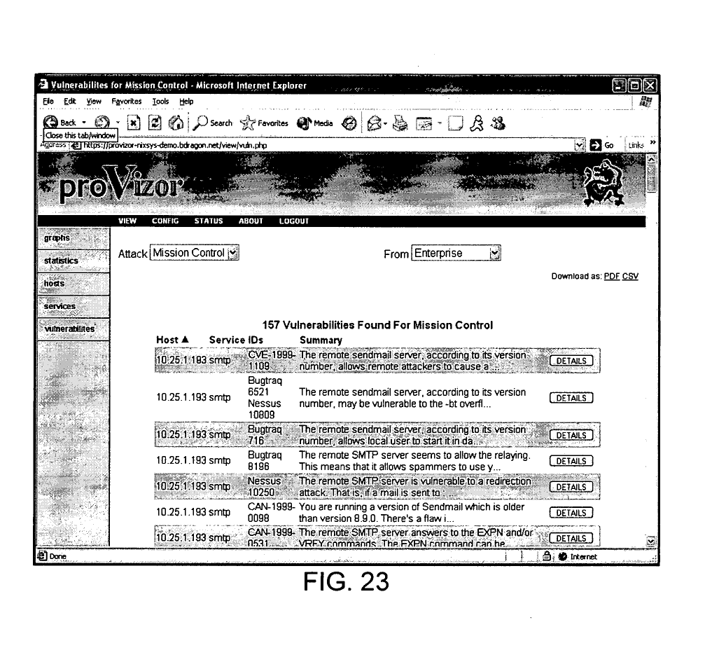

Referring to FIG. 23, vulnerabilities for a given host that effect the time to defeat values are shown. This report displays a list of vulnerabilities identified on the specified host. These vulnerabilities contribute to and affect the time-to-defeat values. In some cases, the time required to compromise a service using a known vulnerability and exploit may take more time than another form of attack on an inherently weak protocol and service. In these scenarios, the procedures used to resolve the weakness will be different. For example, a network administrator may patch the vulnerability instead of implementing a greater security process or making an infrastructure modification.

The vulnerabilities graph also includes a details tab. A user may desire to view information about a particular weakness in addition to the summary displayed on the graph. In order to view additional information about a particular vulnerability, the user selects the details tab to navigate to a details screen. The details screen includes details about the vulnerability such as details that would be generated by a vulnerability analyzer.

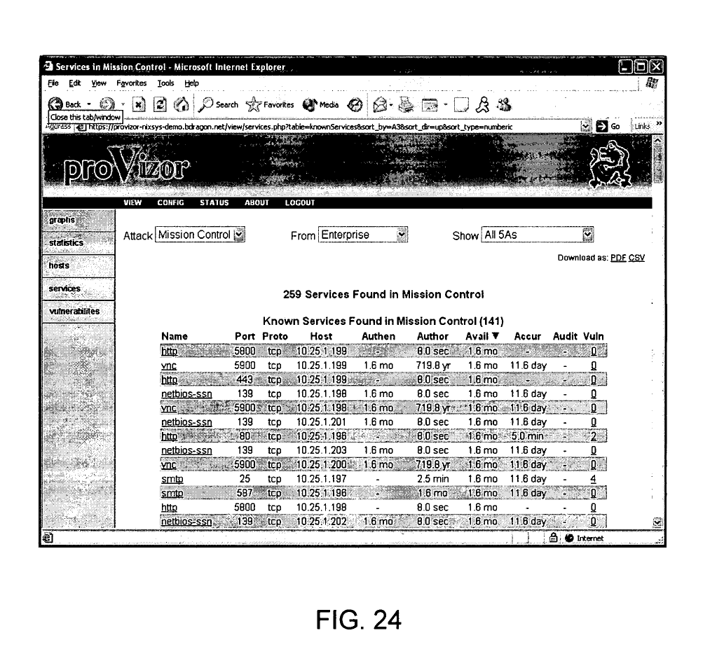

Referring to FIG. 24, a list of discovered services, sorted by availability, high to low is shown. This display is useful for identifying inconsistencies in services across hosts and in analyzing trends of weakness and strength between multiple services. Sorting the services based on the availability syndrome demonstrates the services that are strongest in that area, sorting by service name would show the trends for that service. Sorting by host provides an overall confidence level for that given system, and identifies the system's weakest aspects. If some systems on the analyzed network include important assets or information, the risk of compromise can be ascertained either directly to that system, via the time-to-defeat values for that host/service, or via another system on the same network that is vulnerable and generates a risk of exposure for the other hosts and services on the network.

In addition to viewing information about security on a network or enterprise level (with values for the individual hosts), a user may desire to view security information on a more granular level such as security information for a particular host. In order to view information on a more granular level, the use selects a network or host and selects the hyperlink to the host to view security information for the host.

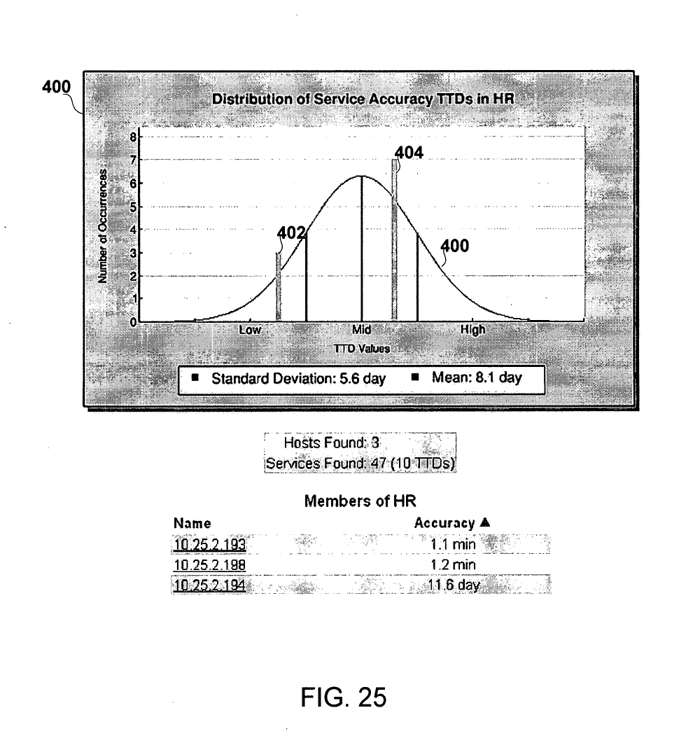

Referring to FIG. 25, a distribution 400 of TTD values for the accuracy syndrome for services on a given network is shown. A wide range can be indicative of inconsistencies and insecurities within the network. The distribution graph provides a general understanding of the data and overall levels of security within a given security syndrome for the services discovered. The grey bars 402 and 404 indicate where the majority of services are relative to each other. In this case, many of the services fall below the normal (“mid”) mark, with a slightly greater number just short of the high section. This information, when combined with the synopsis time-to-defeat values show a low level of security for the syndrome, and consistency in that weakness across the services discovered. The response to these metrics might entail broader policy changes, deployment procedures and configuration updates, rather than fixes for individual hosts and services. If known vulnerabilities are the primary cause of the low security levels, then patch management software; policy and procedure may need augmenting, or the introduction of a system for monitoring traffic and applications. If weaknesses in protocols and services (non-vulnerability) are the main cause of the low security levels, network configuration and security (access control, firewalls and filtering, physical/virtual segmenting) can be used to mitigate the risks.

The distribution information is extremely valuable for an organization to measure their security over time and to prove effectiveness in the processes and procedures. By establishing baselines and thresholds and coordinating those levels with applicable standards, legislation and policy, the enterprise can demonstrate the value of their security process, the network's ability to withstand new attacks and vulnerabilities and to evolve to meet the ever-changing security environment. Comparison of the analyses at different time periods are important for showing the response and diligence of the organization to monitor, maintain, and enhance its security capabilities.

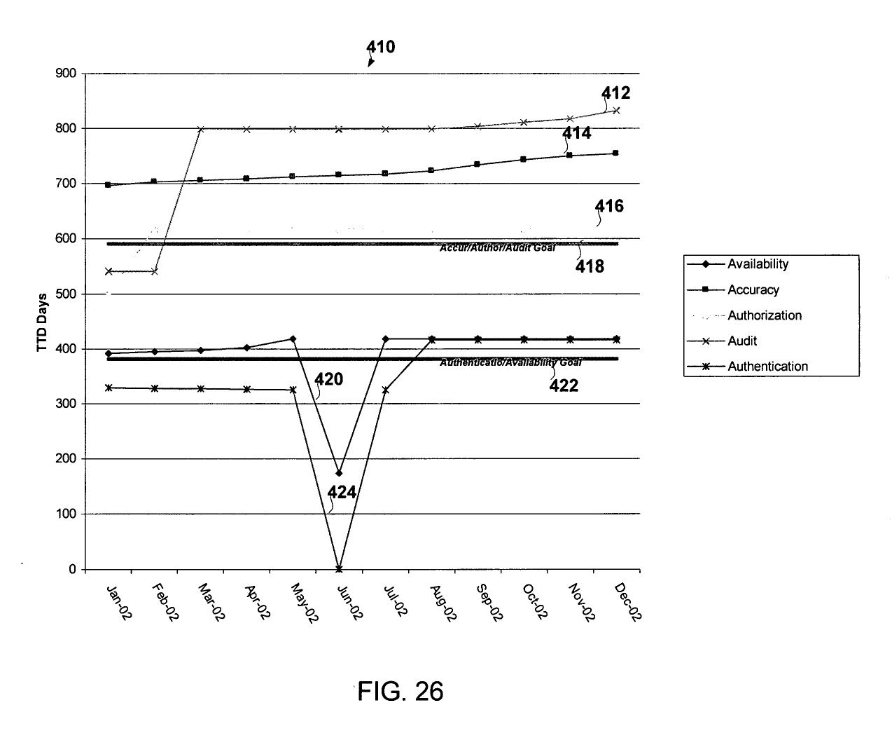

Referring to FIG. 26, a graph 410 that plots a summary of security analyses over time, in relation to established thresholds (horizontal lines 418, 422) is shown. In this example, the thresholds for the Accuracy, Authorization and Audit syndromes are the same (shown as line 422) and the thresholds for the Authentication and Availability syndromes are the same (shown as line 418), however, the thresholds could be different for each of the syndromes. In FIG. 22, each of the syndromes are depicted by lines 412, 414, 416, 420 and 424 respectively. The graph can be used to show any improvements in security characteristics as expressed by the plots of the evaluated syndromes compared to established goals line 418 (corresponding to Accuracy, Authorization and Audit) and line 422 (corresponding to Authentication and Availability). The plots can show a user whether actions that were taken have been effective in enhancing the security levels for the various syndromes.

The plots can also show degradation in security. For instance, the dips in the availability and authentication syndromes (lines 420 an 424) may be indicative of new vulnerabilities that affected the environment, the introduction of an unauthorized and vulnerable computer system to the environment, or the mis-configuration and deployment of a new system that failed to comply with established policies. The return to an acceptable level (e.g., a level above the threshold 422) of security after the drop demonstrates the effectiveness of a response. Graph 410 thus, demonstrates diligence, which can then be communicated to customers or partners, and can be used to demonstrate compliance to regulations and policy.

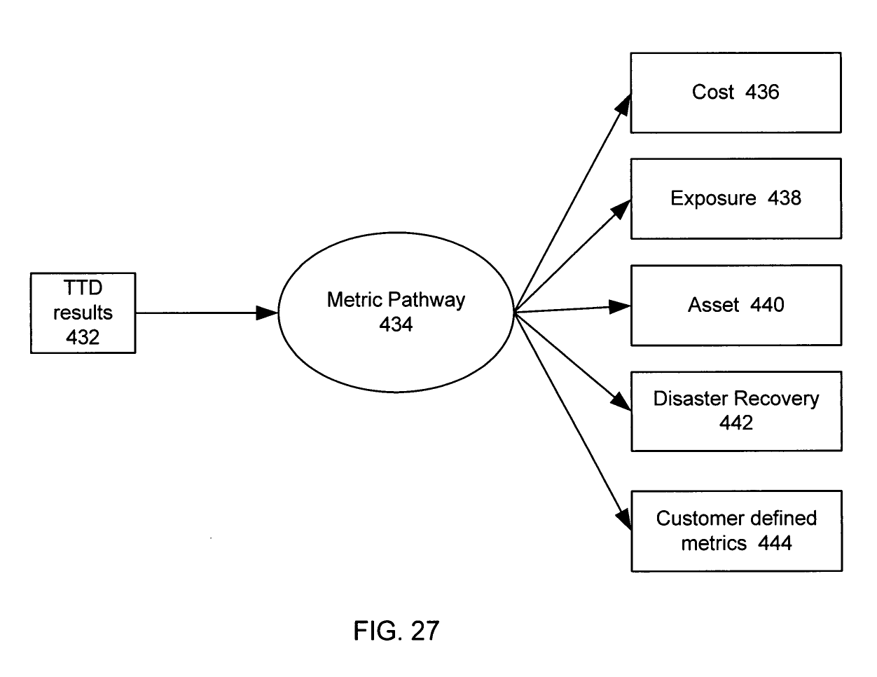

Referring to FIG. 27, in addition to displaying results of the security calculations based on the time to defeat, a metric pathway 434 uses the TTD results 432 to generate other metrics 436, 438, 440, 442, and 444. The metric pathway 434 uses analysis data and calculates/correlates the analysis results with information relevant to the desired report metric. This provides the advantage of allowing the expression of results in forms other than time-to-defeat values. The metrics are permutations based on the TTD values that generate numerical analysis information in other formats. For example, the metric pathway 434 provides a security estimate in terms of financial information such as a cost/loss involved in the compromise of the network or target. The metric pathway 434 may also display results in terms such as enterprise resource management (ERM) quantities, including availability, disaster recovery, and the like. Other metrics such as assets, or customer-defined metrics can also be generated by the metric pathway. Information and algorithms used to calculate metrics can be included in the metric pathway or may be programmed by a user. Thus, the metric pathway 434 provides flexibility and modularity in the security analysis and display of results. The metric pathway is an architectural detail of the modularity within the system. Time to defeat metrics can go through a permutation to present the results in other terms such as money, resources (people, and their time), and the like.

For example, one metric could take the time to defeat metrics and show results in dollar values. The dollar values could be the amount of potential money lost or at risk. This could be determined by correlating asset dollar values to the TTD risk metrics and showing what is at risk. An example of such a report could include an enumeration of time, value, and assets are risk. For example, “in N seconds/minutes/days X dollars could be compromised based on a list of Y assets at risk.”

In some examples, a user may desire to modify network or security characteristics of a system based on the calculated TTD 472 or metric results 474. For example, a user might change the password protection on a computer or add a firewall. In an operational environment, it can be costly to implement security changes. Thus, the security analysis system allows a user to indicate desired changes to the network and subsequently re-calculate the TTD for the target after implementing the changes. This allows a network administrator or user to determine the effect a particular change in the network would make in the overall security of the system before implementing the change.

For example, referring back to FIG. 1, network 12 includes multiple computers (e.g., 16a-14d) connected by a network or communication system 18. A firewall separates another computer 15 from computers 16a-16d in network 12. As described above, TTD results can be caluculated for the network. Based on the results, a user may desire to determine the effect of adding a component or changing a feature of the network to improve the security of the network (e.g., to increase the TTD). In order to determine the effect adding a component would have on the overall secururity, a user specifies a location and settings for an additional component. For example, is a path from computer 16d to 16a resulted in a low level of security, a firewall could be added in the path between computer 16d and 16a. Based on the added component, the system generated new attack trees and calculates new TTD results. The new TTD results give the user an indication of an estimated level of security if the firewall were added to the physical network. In another example, settings for individual components in the network could be modified. For example, if a low TTD value was generated based on an attack exploiting passwords, the user could specify a different password structure (e.g., increase the number of letters or require non-dictionary passwords) and recalculate the TTD results.

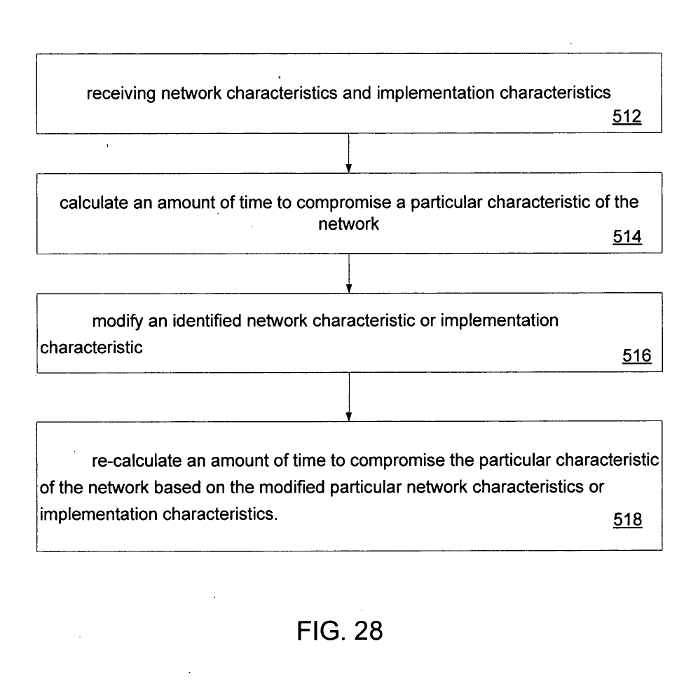

Referring to FIG. 28 a process 510 for determining the effect of a change in the network layout or security characterizes on the time to defeat is shown. Process 510 includes receiving 512 network characteristics and implementation characteristics. These characteristics are used to calculate 514 an amount of time to compromise a particular characteristic of the network using attack trees and TTD algorithms (as described above). A user modifies 516 a particular network characteristic or implementation characteristic. Based on the re-configured characteristics, the system re-calculates 518 an amount of time to compromise the target. By comparing the time to defeat prior to the changes in the network to the time to defeat after the changes have been implemented, a network administrator or other user determines whether to implement the changes.

Alternative versions of the system can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. Accordingly, other embodiments are within the scope of the following claims.

What is claimed is:

1. A computer based method comprising:
identifying vulnerabilities of a network based on a set of known vulnerabilities related to characteristics of the network;
simulating, based on the characteristics of the network and the identified vulnerabilities, at least one attack on a target in the network; and
calculating at least one time value representative of an estimated time to compromise the target based on the simulated attack.

2. The method of claim 1 further comprising receiving information about characteristics of a network;

3. The method of claim 1 wherein the set of known vulnerabilities includes implementation vulnerabilities associated with a product.

4. The method of claim 1 wherein the set of known vulnerabilities includes vulnerabilities inherent to a particular protocol.

5. The method of claim 1 wherein the identified vulnerabilities relate to how attacks are implemented.

6. The method of claim 1 wherein receiving information includes receiving information from a network analyzer.

7. The method of claim 1 further comprising categorizing the vulnerabilities into a plurality of categories.

8. The method of claim 7 wherein the categories include authentication, authorization, availability, accuracy, and audit.

9. The method of claim 1 further comprising calculating multiple time values related to different vulnerabilities; and
displaying the lowest calculated time value of the multiple calculated time values.

10. The method of claim 1 further comprising displaying a list of vulnerabilities for the network.

11. A computer program product, tangibly embodied in an information carrier, for executing instructions on a processor, the computer program product being operable to cause a machine to:
identify vulnerabilities of a network based on a set of known vulnerabilities related to characteristics of the network;
simulate, based on the characteristics of the network and the identified vulnerabilities, at least one attack on a target in the network; and
calculate at least one time value representative of an estimated time to compromise the target based on the simulated attack.

12. The computer program product of claim 11 further comprising instructions to cause a machine to receive information about characteristics of a network;

13. The computer program product of claim 11 wherein the set of known vulnerabilities includes at least one vulnerability selected from the group consisting of implementation vulnerabilities associated with a product and vulnerabilities inherent to a particular protocol.

14. The computer program product of claim 11 further comprising instructions to cause a machine to categorize the vulnerabilities into a plurality of categories.

15. The computer program product of claim 14 wherein the categories include authentication, authorization, availability, accuracy, and audit.

16. The computer program product of claim 11 further comprising instructions to cause a machine to:
calculate multiple time values related to different vulnerabilities;
display the lowest calculated time value of the multiple calculated time values; and
display a list of vulnerabilities for the network.

17. An apparatus configured to:
identify vulnerabilities of a network based on a set of known vulnerabilities related to characteristics of the network;
simulate, based on the characteristics of the network and the identified vulnerabilities, at least one attack on a target in the network; and
calculate at least one time value representative of an estimated time to compromise the target based on the simulated attack.

18. The apparatus of claim 17 wherein the set of known vulnerabilities includes at least one vulnerability selected from the group consisting of implementation vulnerabilities associated with a product and vulnerabilities inherent to a particular protocol.

19. The apparatus of claim 17 further configured to categorize the vulnerabilities into a plurality of categories.

21. The apparatus of claim 18 wherein the categories include authentication, authorization, availability, accuracy, and audit.

22. The apparatus of claim 17 further configured to:
calculate multiple time values related to different vulnerabilities;
display the lowest calculated time value of the multiple calculated time values; and
display a list of vulnerabilities for the network.
